(19) United States
(12) Patent Application Publication
(10) Pub. No.: US 2007/0166606 A1
(43) Pub. Date: Jul. 19, 2007

(54) Hinged battery vent cap and related ganged vent assembly

(76) Inventors: William B. Brecht, Long Beach, CA (US); Joel Jay Briggs, San Bernardino, CA (US)

Correspondence Address: CHRISTIE, PARKER & HALE, LLP, PO BOX 7068, PASADENA, CA, 91109-7068, US

(21) Appl. No.: 11/333,841

(22) Filed: Jan. 17, 2006

(51) Int. Cl. H01M 2/36; H01M 2/12

(52) U.S. Cl. 429/72; 429/89; 429/87

(57) ABSTRACT

A deep cycle battery is provided that has at least one vent cap. Each vent cap is capable of entry into and exit from a fill opening in a battery cover. The vent cap is attached to the battery cover by a hinge connection which allows for play between the vent cap and the battery cover and which allows for rotation of the vent cap. In one embodiment, a ganged vent assembly is provided in which a flip top cover containing a series of vent caps allows an operator to remove the vent caps from the fill openings all at once, and the insert the vent caps into the fill openings all at once.

### BACKGROUND OF THE INVENTION

The present invention is directed to the field of deep cycle lead acid batteries.

Battery vent caps are placed over fill openings in the battery which provide access to reservoirs containing the electrolyte. The vent caps seal the reservoirs from the surrounding environment, and can provide a vent for allowing gases produced during battery operation to escape from the battery. The vent caps are removed periodically for watering the battery to replace water lost due to evaporation or electrolysis.

### SUMMARY OF THE INVENTION

In one embodiment of the present invention, a hinged battery cap assembly for a lead-acid battery includes a battery cover with a built-in watering fill well, a removable cap adapted to seal the watering fill well, and a hinge for connecting the removable cap to the battery cover. The hinge is formed of a hinge pin and a hinge socket, wherein the hinge pin floats within the hinge socket to allow movement of the hinge pin along the length of the hinge pin with respect to the hinge socket.

In another embodiment, a seal is included. In yet another embodiment, an indicator pin is included and adapted to engage an aperture in the cap when the cap is in a sealed position. Is still yet another embodiment, the fill well includes a stop ring at a bottom end.

In another embodiment, the hinge socket is larger than the hinge pin. In yet another embodiment, the hinge pin can be snapped into and out of the hinge socket. In still yet another embodiment, additional removable caps are included, and each removable cap is joined to a flip top cover.

In one embodiment, a ganged battery cap assembly for a lead-acid battery includes a battery cover having a plurality of watering fill wells, a removable cap associated with each watering fill well and adapted to seal the respective watering fill well, a hinge connecting each removable cap to the battery cover, and a flip top cover adapted to join the plurality of removable caps to one another. Each removable cap is joined to the flip top cover with an amount of play such that each removable cap independently floats with respect to the flip top cover.

In another embodiment, at least one seal is included and adapted to seal the cap to its respective watering fill well. In yet another embodiment, an indicator pin is included and associated with each fill well, and each indicator pin is adapted to engage a corresponding aperture in the cover when the caps are in sealed positions.

In another embodiment, the hinge socket is slightly larger than the hinge pin to allow movement of the hinge pin in three dimensions with respect to the hinge socket. In yet another embodiment, the flip top cover includes at least one elastically deformable bracket for joining the cap to the flip top cover.

In one embodiment, the fill well is removable from the battery cover.

### BRIEF DESCRIPTION OF THE DRAWINGS

FIG. 1 is a side view of a deep cycle battery according to the present invention;

FIGS. 2A and 2B are perspective and cross sectional views, respectively, of a battery cover of the battery of the present invention;

FIGS. 3A and 3B are a top view and a cross sectional view along the line 3B-3B respectively, of a vent cap of the battery;

FIGS. 4A and 4B are side view of the vent cap and the battery cover assembled;

FIGS. 5A and 5B are cross sectional views of the vent cap and the battery cover assembled;

FIGS. 6A and 6B, and a cross sectional view along the line 6C-6C respectively, of a flip top cover of the battery;

FIG. 7 is a cross sectional view of the flip top cover and the vent caps assembled;

FIG. 8 is a cross sectional view of an alternative vent cap;

FIGS. 9A and 9B are top and cross sectional views, respectively, of an alternative fill well of the battery cover which is detachable from the battery cover;

FIGS. 10A and 10B are perspective and cross sectional views, respectively, of an alternative vent cap;

FIGS. 11A to 11C are perspective, top, and cross sectional view, respectively, of an alternative battery cover; and

FIG. 12 is a cross sectional view of the vent cap of FIGS. 10A and 10B and the battery cover of FIGS. 11A to 11C assembled.

### DETAILED DESCRIPTION OF THE INVENTION

The detailed description set forth below in connection with the appended drawings is intended as a description of certain embodiments including the presently preferred embodiments provided in accordance with aspects of the present invention and is not intended to represent the only forms in which the present invention may be constructed or utilized. The description sets forth the features and the steps for constructing and using the battery of the present invention in connection with the illustrated embodiments. It is to be understood, however, that the same or equivalent functions and structures may be accomplished by different embodiments that are also intended to be encompassed within the spirit and scope of the invention.

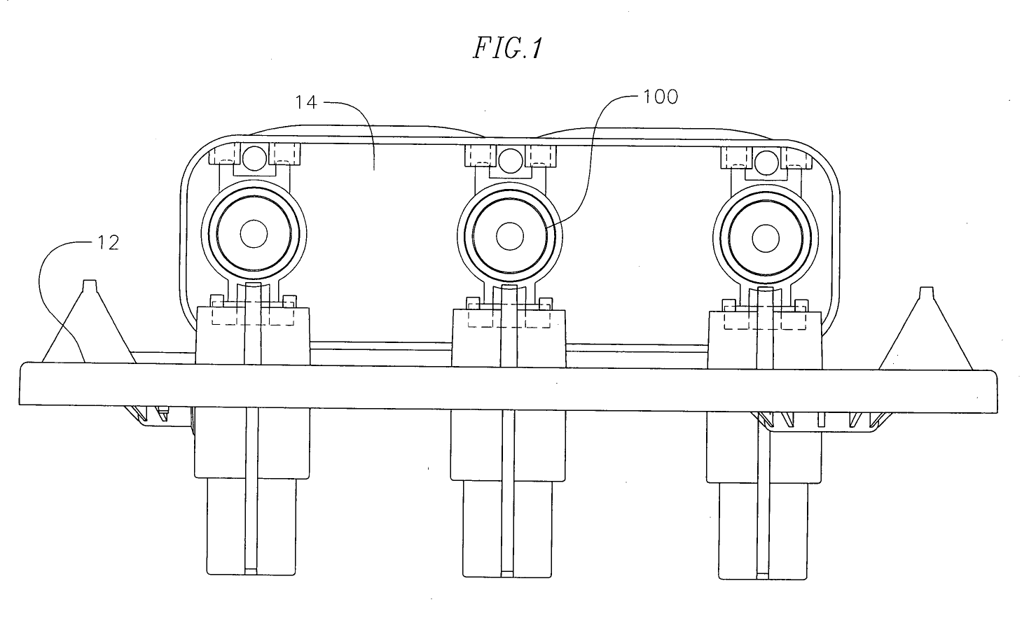

FIG. 1 shows a battery cover 12 for a deep cycle battery. The battery cover includes, a series of hinged vent caps 100 for sealing fill openings (not shown in FIG. 1) of the battery cover 12. The hinged vent caps 100 are ganged together by a flip top cover 14.

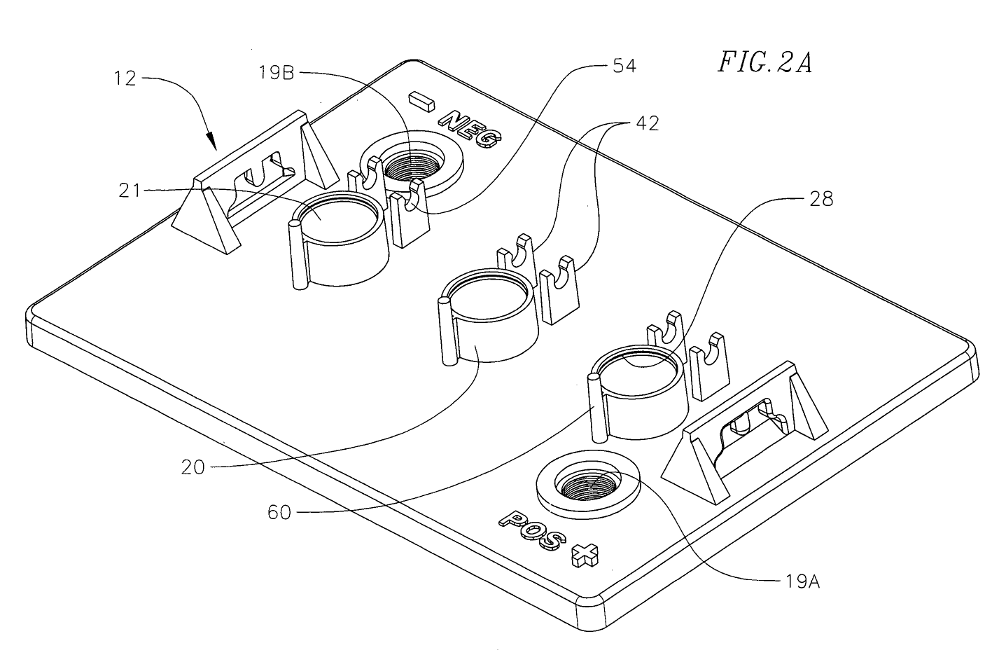

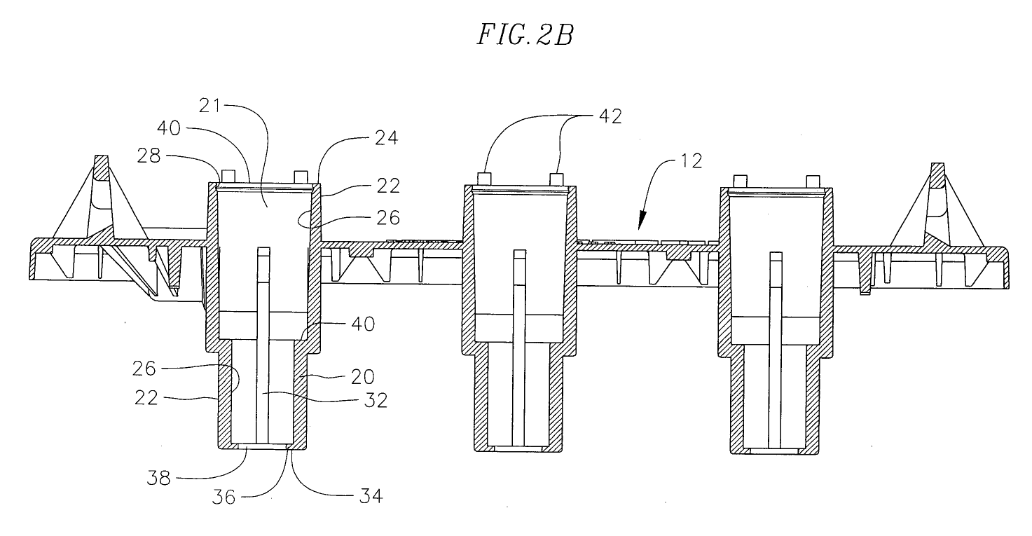

With reference to FIGS. 2A and 2B, the battery cover 12 is generally rectangular in shape and includes positive and negative terminal openings 19A, 19B extending through the battery cover 12. Fill wells 20 extend perpendicularly through the battery cover 12 and into the battery, each defining a fill opening 21 for filling the battery with a fluid such as water. The interior of each fill opening 21 defines an inner sealing groove 28 which extends around the circumference of the fill opening 21.

A lower end 34 of each fill well 20 includes a plurality of longitudinal slot openings 32 through which liquid may flow from the fill well 20 into the battery. The lower end 34 of each fill well 20 further defines a stop ring 36 with a central aperture 38. The stop ring prevents a watering gun or other filling device from being pushed too far into the battery which can damage the electrode plates. Part way down the fill well 20, a ledge surface 40 faces towards the battery cover 12. Below the ledge surface 40, the fill well 20 narrows. The ledge surface may be placed at a position corresponding to preferable water level. For watering guns that include an automatic shut-off device, the ledge surface provides a convenient shelf upon which the watering gun may rest during filling so that the watering gun may shut off at the proper water level. The ledge surface and stop ring further permit visual inspection of the electrolyte level when adding liquid without a watering gun, or when determining whether or not liquid should be added.

Hinge brackets 42 extend perpendicularly from the top surface of the battery cover 12 to link with the vent caps 100 as will be discussed in further detail below. A pair of hinge brackets 42 is associated with each fill well 20. Each hinge bracket 42 defines a hinge pin aperture 54. For this embodiment, each hinge pin aperture is slotted for ease in assembling the associated vent cap 100 (see FIG. 1). The hinge pin apertures 54 are aligned with one another along a common axis for reasons which will be discussed later.

Each fill well 20 also includes a corresponding indicator pin 60 extending perpendicularly from the battery cover 12. The indicator pins 60 are useful for visually inspecting whether the fill openings 21 have been properly plugged with the vent caps 100 as will be described below.

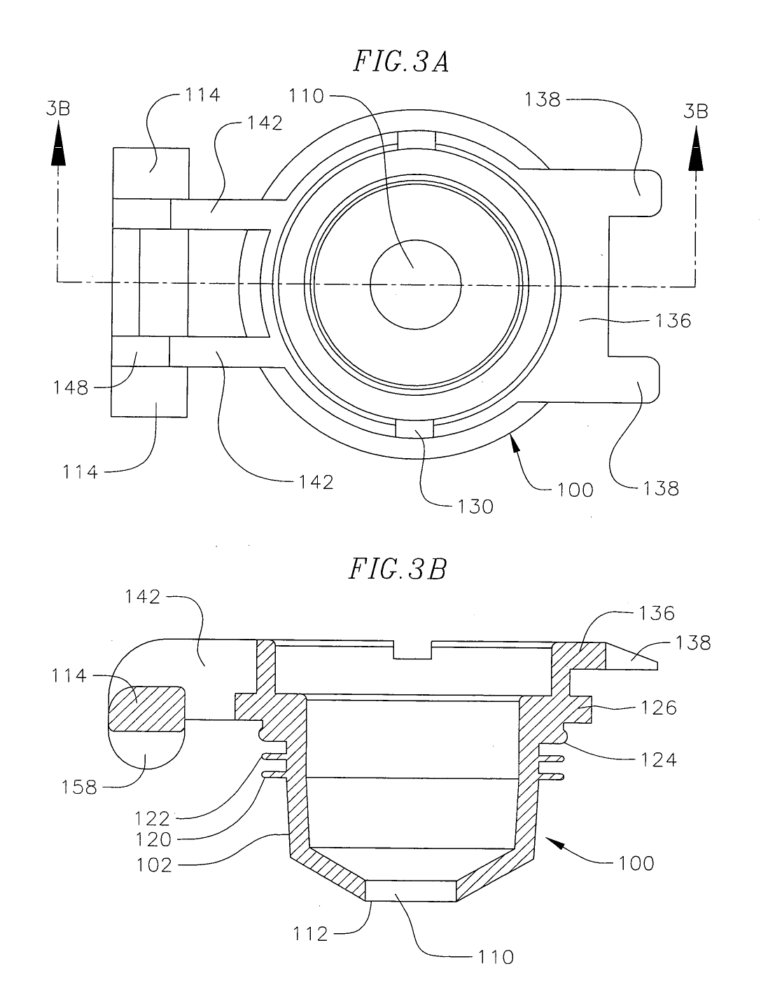

As shown in FIGS. 3A and 3B, a removable vent cap 100 is provided for each fill opening 21 (see FIGS. 2A and 2B). Each vent cap 100 includes a cylindrical plug body 102. According to the embodiment illustrated, each plug body 102 is hollow, defining a recess into which a flame arrester (not shown) may be inserted. Such flame arresters are well known in the art. The flame arrester communicates with the interior of the battery through an aperture 110 at the bottom of the plug body.

The outer surface of each vent cap 100 includes first, second, and third annular seals 120, 122, 124 extending circumferentially around the plug body 102. Each seal may be engaged with the inner sealing groove 28 of the corresponding fill well 20. Each vent cap also includes a circumferential shoulder 126 facing a bottom end 112 of the vent cap 100.

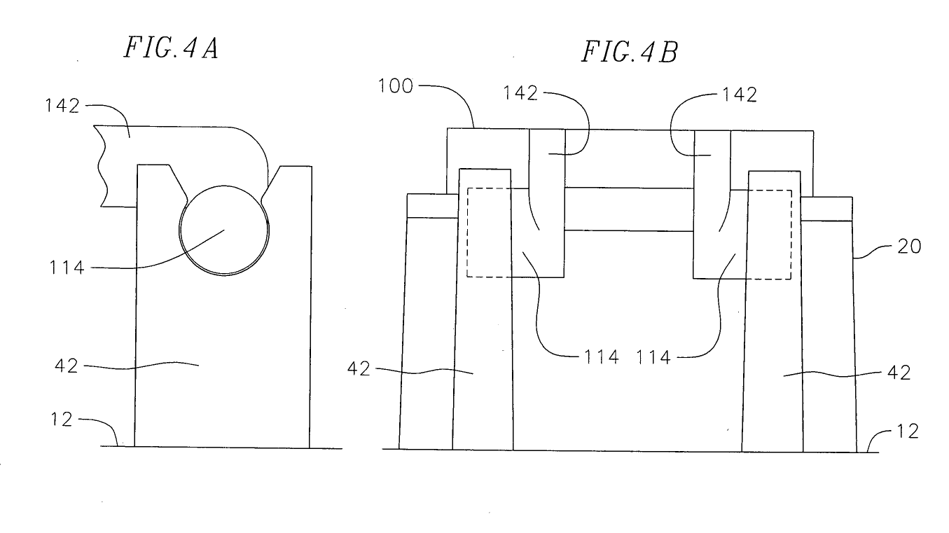

Each vent cap 100 includes a hinge pin 114 joined to and spaced a distance from the plug body 102 by a pair of hinge arms 142. In the area between the hinge arms 142, the hinge pin 114 includes a notch 158. Each hinge pin 114 cooperates with the corresponding pair of slotted hinge pin apertures 54 (see FIG. 2A) of the hinge brackets 42 as shown in FIGS. 4A and 4B. According to one embodiment of the invention, the hinge pin apertures 54 (see FIG. 2A) are slightly larger than the hinge pin 114, allowing some play between the vent caps 100 and the battery cover 12 while still allowing the vent caps 100 to be securely fastened to the hinge brackets 42. Furthermore, in one embodiment, the hinge arms 142 of a particular vent cap 100 are located between the corresponding pair of hinge brackets 42, and are spaced somewhat closer together than the hinge brackets 42. This permits some additional play between the flip-top cover 14 and the battery cover 12 along the axis of the hinge pin. This play permits the plug body some movement when closing the top cover 14 so that the plug bodies 102 of the vent caps 100 may center themselves within the appropriate fill opening 21 (see FIG. 2B) to help to ensure a proper seal, even if there are minor imperfections in the molding of the battery cover 12 or the vent caps 100.

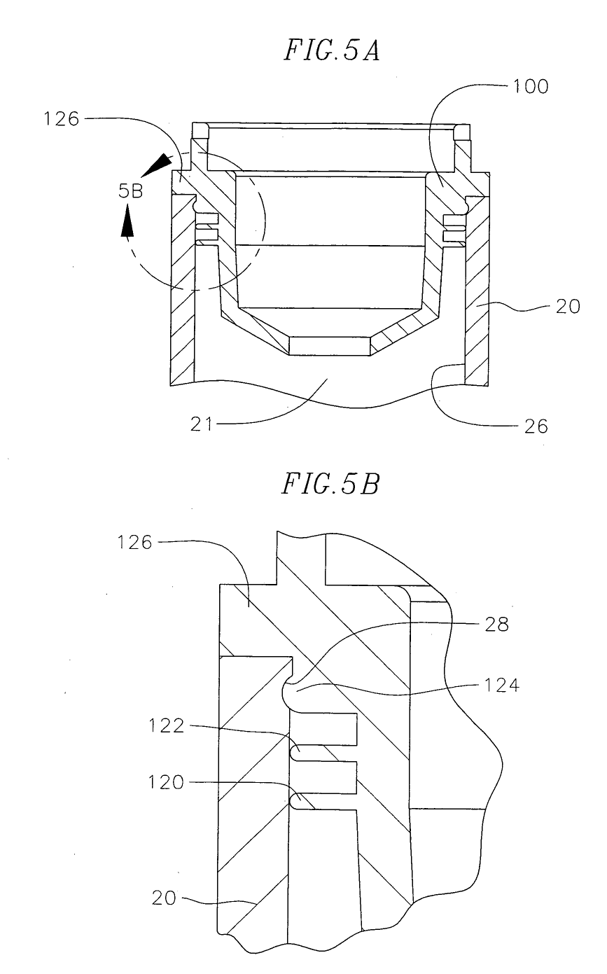

With reference to FIGS. 5A and 5B, in closing the vent cap 100, the plug body 102 swivels about the axis defined by the hinge pin 114 until the plug body 102 (see FIGS. 4A and 4B) enters the corresponding fill opening 21 of a fill well 20 of the battery cover 12 (see FIGS. 2A and 2B). The first, second, and third annular seals 120, 122, 124 of the vent cap 100 enter the fill opening 21 and the third annular seal 124 engages the inner sealing groove 28 of the fill well 20 to seal the fill well 20. While in closing the vent cap 100, it is preferred that the third annular seal 124 engage the inner sealing groove 28 of the fill well to form the seal, in the event that the vent cap 100 is not fully pressed into the fill opening 21, the first and second annular seals 120, 122 are capable of providing an adequate seal by engaging the side walls of the fill well 20 (see FIGS. 2A and 2B).

With reference again to FIGS. 3A and 3B, opposite the hinge arms 142, a shelf 136 extends from the plug body 102 with a pair of tabs 138 extending from the shelf. The tabs also assist in linking the vent cap 100 to the flip top cover 14 as will be described later.

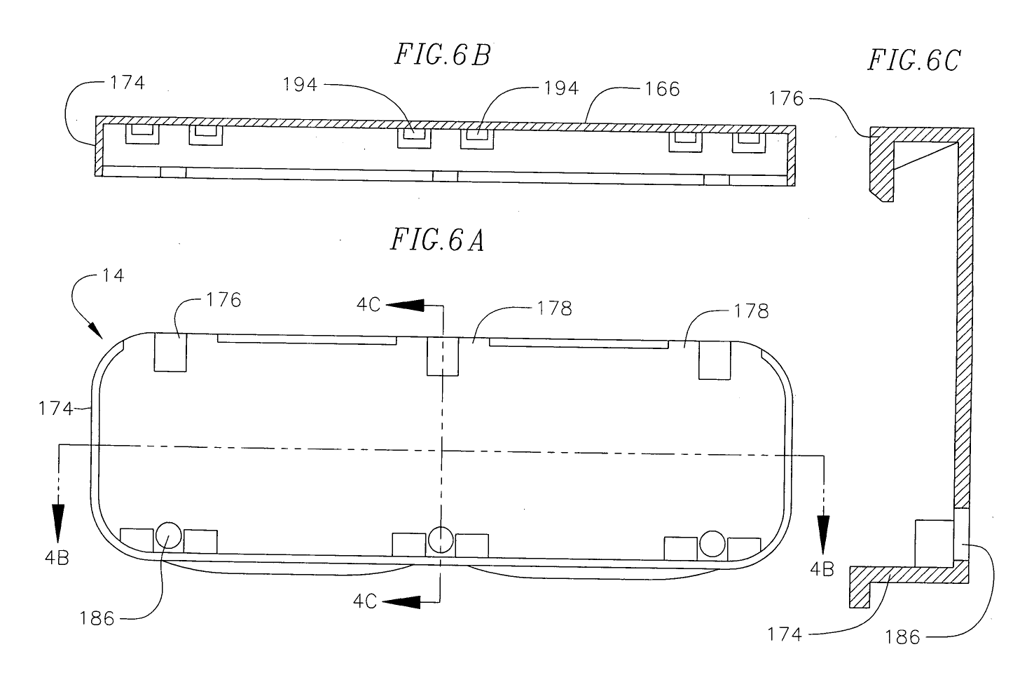

With reference to FIGS. 6A to 6C, the flip top cover 14 is generally rectangular in shape with a lip 174 extending around its outer perimeter. The lip 174 includes a plurality of L-shaped brackets 176, one associated with each fill well 20 (see FIGS. 2A and 2B). On either side of each L-shaped bracket 176 are a pair of cut-outs 178 in the lip 174 which allow the L-shaped brackets to be elastically deformed for mounting the vent caps 100 (see FIG. 3A) to the flip top cover 14 as described below.

Three circular indicator openings 186 are provided through the flip top cover 14, one corresponding to each indicator pin 60 of the battery cover 12 (see FIG. 2A). A pair of pockets 194 are provided toward the lip 174 of the flip top cover 14 with one pocket 194 on each side of each indicator opening 186.

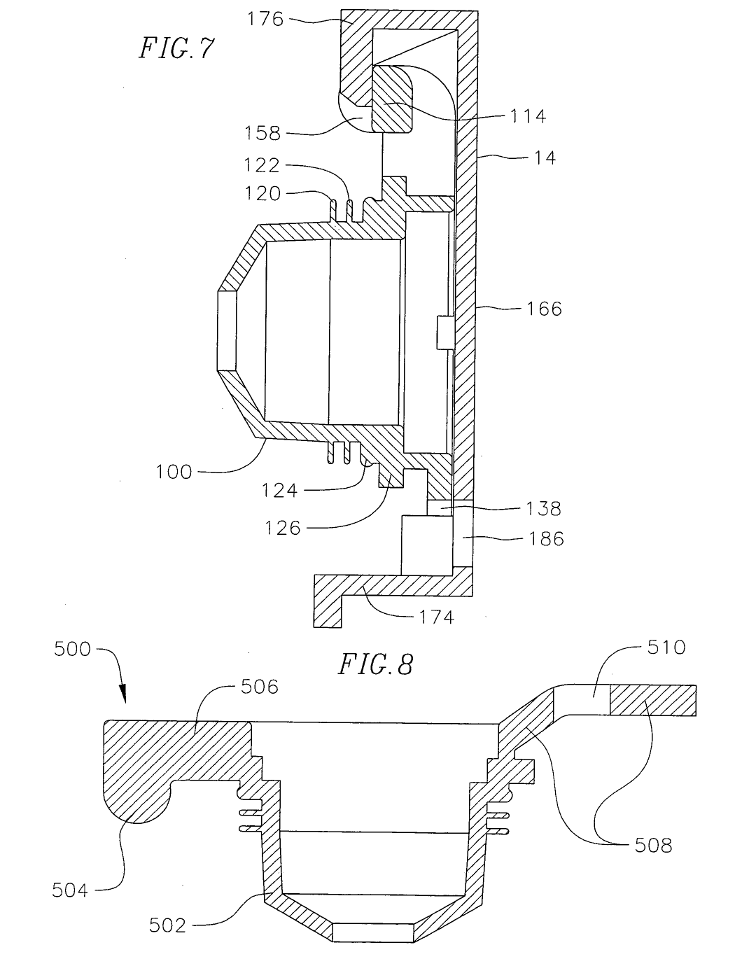

With reference to FIG. 7, each vent cap 100 connects to the flip top cover 14 with the tabs 138 inserted into the pockets 194 of the flip top cover 14 and one of the L-shaped brackets 176 wrapping around the notch 158 of the hinge pin 114 (see FIGS. 3A and 3B). The tabs 138 do not fully engage the pockets 194 of the cover 14, permitting some play between the vent caps 100 and the flip top cover 14 in three dimensions. Similarly, the L-shaped brackets 176 fit loosely to the notches 158 of the hinge pins 114, also permitting some play between the elements. By building such play into the connections between the vent caps 100 and the cover 14, a number of vent caps 100 can easily be ganged together to properly seal the fill openings 21 of the battery cover 12 despite minor imperfections in the manufacture of the flip top cover 14 and the battery cover 12. Because the hinge pins 114 of the plurality of vent caps 100 are arranged to share a common axis, the plurality of vent caps may be opened and closed together as a unit using the flip top cover 14.

With reference again to FIGS. 5A and 5B, the annular shoulder 126 of each vent cap 100 remains outside the fill opening 21, with the shoulder 126 bearing against the top of the fill well 20 (see FIG. 2B) when the vent cap 100 is in its sealed position. In this position, the indicator pins 60 of the battery cover 12 (see FIG. 2A) engage the circular indicator openings 186 of the flip top cover 14 (see FIGS. 6A and 6C). If the vent caps 100 have not properly sealed the fill wells 20, the indicator pins 60 will not be centered within the indicator openings 186, or will not be flush with the top of the flip top cover 14. The use of the indicator pins and indicator openings permits a quick visual inspection of the indicator pins 60 to determine if the vent caps 100 have been properly sealed to the fill wells 20. According to one embodiment of the invention, the indicator pins 60 are of a contrasting color from the flip top cover 14 to further simplify the visual inspection.

When the flip top cover 14 is lifted (see FIG. 1), the vent caps 100 are pulled from the fill openings 21 of the battery cover 12 (see FIGS. 2A and 2B). The play exhibited between the vent caps 100 and the battery cover 12 simplify removal of the vent caps 100 from the fill wells 20 by permitting the vent caps 100 to exit the fill openings 21 in a more vertical manner, and also prevent the vent caps 100 from binding within the fill wells 20.

Once the flip top cover 14 is lifted and the vent caps 100 are removed from the fill openings 21, the operator can then fill the deep cycle battery 10 with water or electrolyte. As mentioned above, a fill hose may be placed within the fill opening 21 (see FIGS. 2A and 2B), to release the water or electrolyte. The liquid enters the fill opening 21, and passes to an electrolyte reservoir below through the slot openings 32 and the stop ring opening 38. As explained above, the ledge surface 40 (see FIGS. 2A and 2B) provides a stop surface on which the fill hose can bear, preventing the fill hose from entering the electrolyte reservoir. The stop ring 36 provides an additional stop surface for the fill hose or any other object which is placed past the ledge surface 40. Potential damage caused by contact between the fill hose and the separators and electrodes located inside the battery 10 is averted and precise filling can be achieved, either by visual inspection or by using a watering gun with an automatic shut off feature.

Once the operator has finished filling the battery 10, the fill hose is removed from the fill openings 21 and the flip top cover 14 is pressed back into its closed position (see FIG. 7). The play exhibited between the vent caps 100 and the battery cover 12 allows the vent caps 100 to center themselves within the respective fill openings 21 and also allows the vent caps 100 to enter the fill openings 21 in a more vertical manner for simpler entry.

Once the flip top cover 14 is placed over the fill wells 20, the operator can ensure the top cover caps 100 have entered into the fill openings 21 by inspecting whether the indicator pins 60 are centered within the indicator openings 186 and flush with top surface 166 of the flip top cover 14 (see FIGS. 6A and 6B).

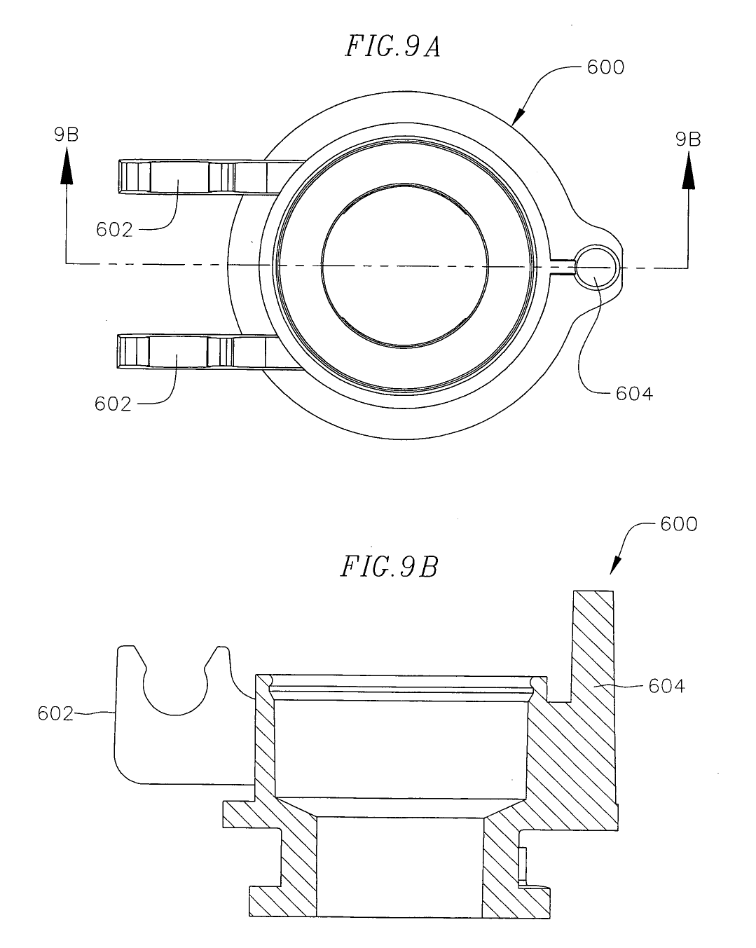

With reference to FIG. 8, in an alternative embodiment, in place of the ganged vent assembly described above, the battery 10 includes individually-operated vent caps 500 for use with a battery cover 12 such as is described above. Like the previously described vent cap, each vent cap 500 includes a plug body 502 for sealing the fill opening, a hinge pin 504 connected to the plug body 502 by a pair of hinge arms 506, and a shelf 508 for easy removal of the vent cap 500 from the fill opening 21 (see FIGS. 2A and 2B). The hinge pin cooperates with the hinge brackets of the battery cover as described above. However, since no flip top cover is used, the shelf 502 includes an indicator opening 510. As in the previous embodiment, the indicator opening 510 permits simple visual inspection of the vent cap 500 to determine if the plug body 502 has properly been seated within the fill well.

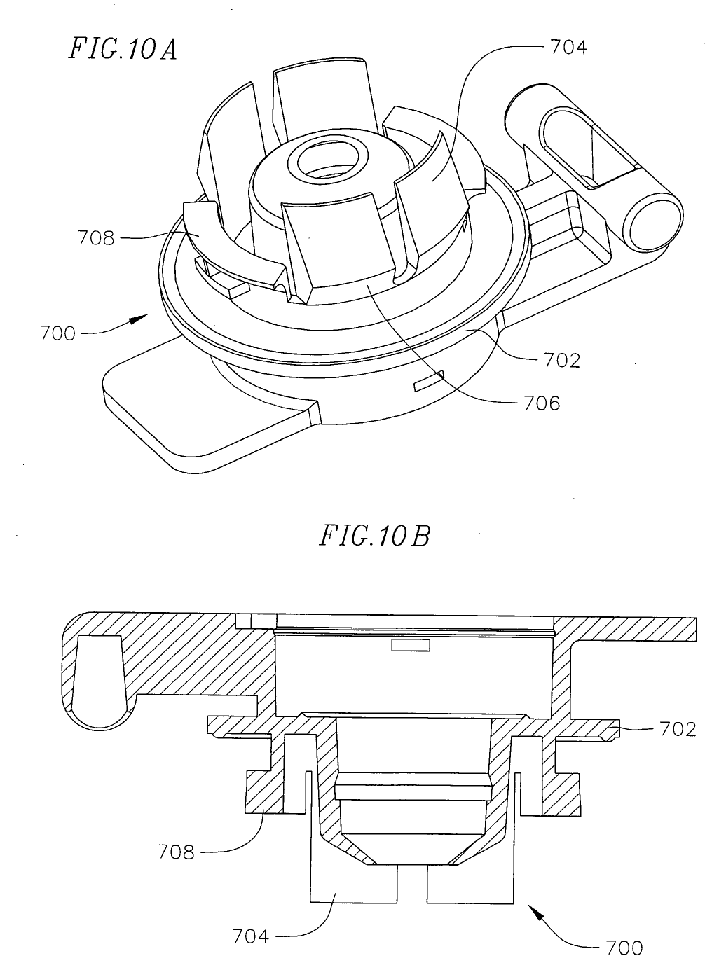

With reference to FIGS. 9A and 9B, in another alternative embodiment, a fill well 600 is provided that is detachable from the battery cover 12. For this embodiment, each fill well may include an integral pair of hinge brackets 602 and an integral indicator pin 604. The fill well 600 can be attached to the battery cover 12 by known connectors. Examples of such connectors include threaded connectors and ¼-turn bayonet mount connectors. Once connected to the battery cover, the fill wells may be used as described above. Such an embodiment is useful for retrofitting an existing battery cover that already includes fill well connectors to employ the ganged flip top cover assembly and other features of the present invention.

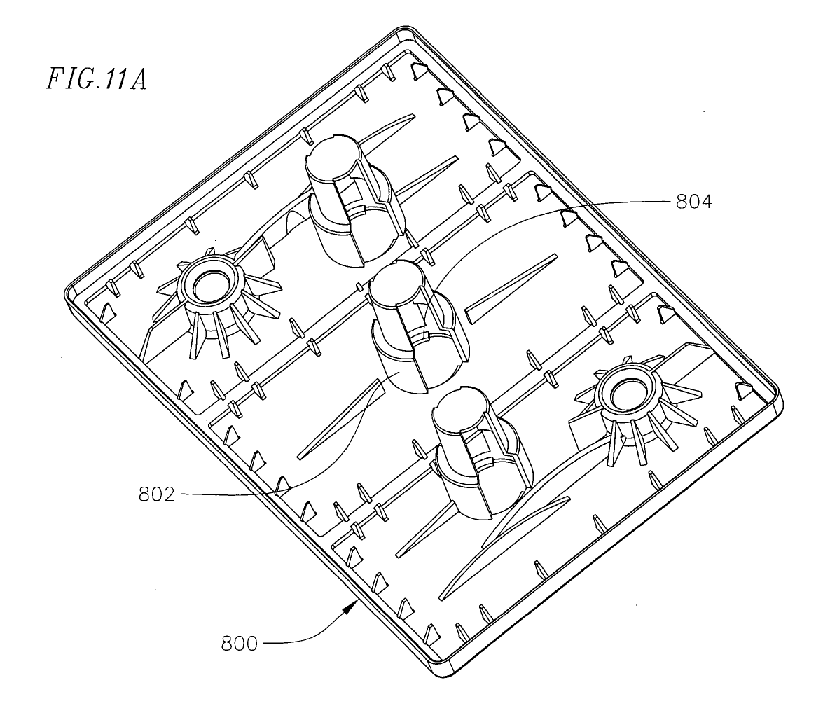

With reference to FIGS. 10A and 10B, a vent cap 700 with an alternative sealing mechanism is illustrated. Features of this embodiment are illustrated in U.S. Pat. No. 5,356,734 which is incorporated by reference in its entirety. The vent cap 700 includes a shoulder 702 extending radially outwardly from the vent cap 700. Claw-shaped flanges 704 extend generally downwardly from the shoulder 702 and include a peak 706 running helically around a circumference of the vent cap 700. Arm flanges 708 extend downwardly from the shoulder 704 and then extend outwardly from the vent cap 700 to engage the inner surface of a fill well. The claw-shaped flanges 704 are flexible, and flex inwardly when inserted into the fill well of the battery cover, as described below.

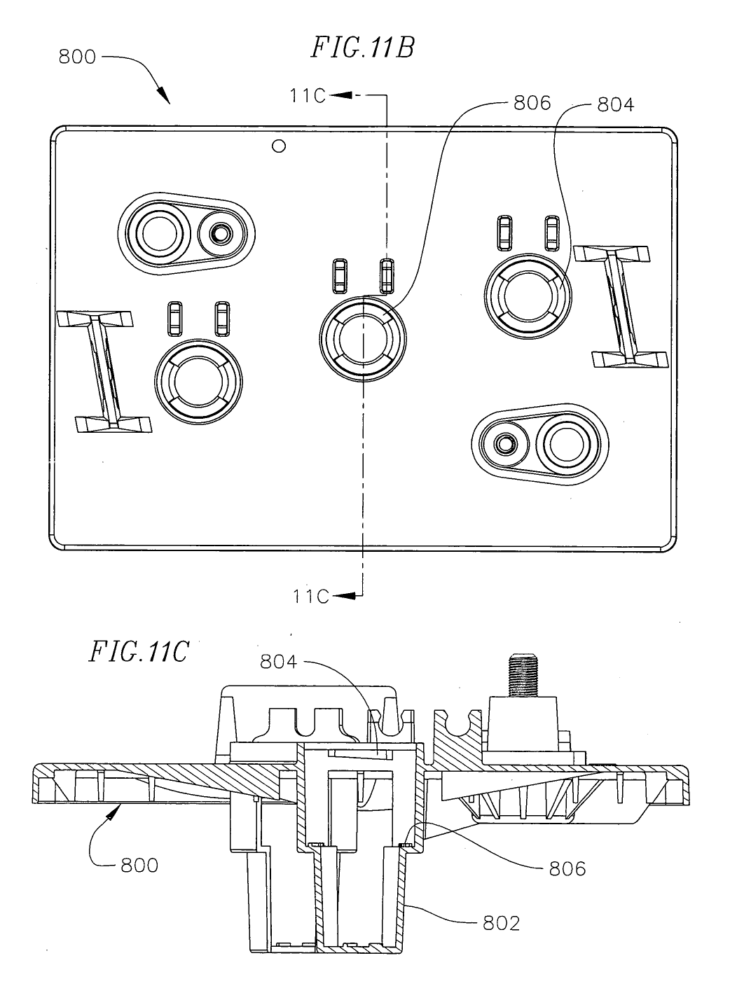

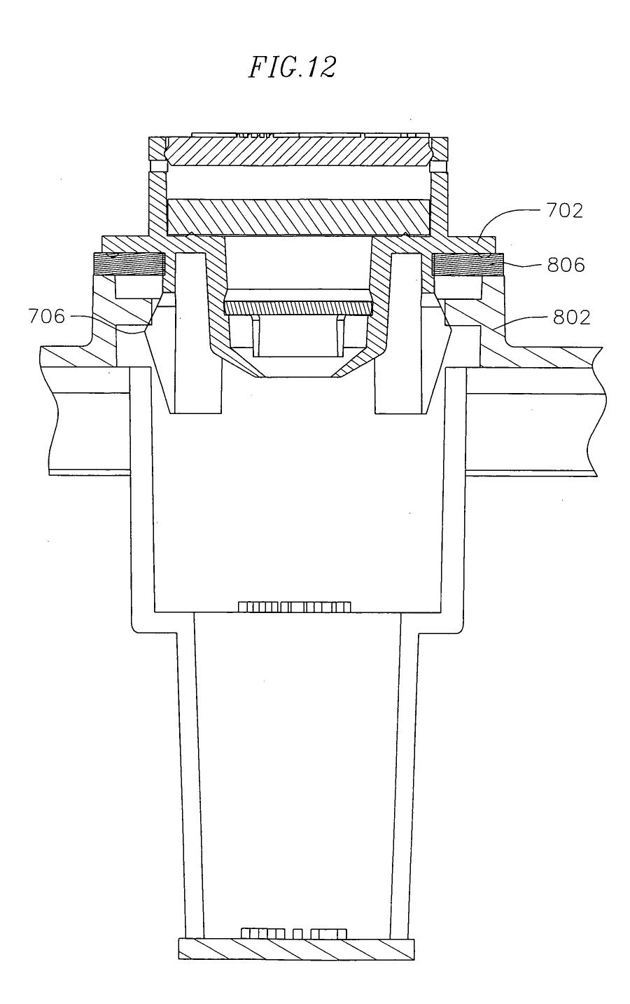

With reference to FIGS. 11A to 11C, in an alternative embodiment, a battery cover 800 includes at least one fill well 802. Near the top, the fill well 802 includes ears 804 past which claw-shaped flanges 704 may be placed. In a lower portion, the fill well 802 includes a bottom surface upon which the word MIN may appear for convenience in filling the battery. A ledge surface 806 may be formed on the inside surface of the fill well 802, and faces upward. The word MAX may be written on the ledge surface 806 for convenience in filling the battery.

The vent cap 700 and the battery cover 800 are fitted together by a hinge connection, described above with respect to other embodiments of the invention. As shown in FIG. 12, the vent cap 700 enters the fill well 802, and the claw-shaped flanges 704 flex inwardly, passing over the ears 804 of the fill well 802. The arm flanges 708 bear against the inner surface of the fill well 802. In the fully inserted position, the peaks 706 of each claw-shaped flange 704 pass below the ears 804 of the fill well 802, and the spring pressure of the claw-shaped flange 704 against the ear 804 draws the vent cap 700 into the fill well 802 such that a shoulder 702 of the vent cap 700 bears against a top surface of the fill well 802.

A resilient washer 806 can be placed on the shoulder 702 of the vent cap 700. As explained above, the outward pressure exerted by the claw-shaped flanges 704 draws the vent cap 700 into the fill well 802, and the shoulder 702 bears on the top of the fill well 802. The resilient washer, pressed between the top of the fill well 802 and the vent cap 700, helps to form a seal therebetween.

In other embodiments of the invention, rather than placing the hinge pins on the vent caps and the hinge brackets on the battery cover, the hinge parts can be reversed with the hinge brackets on the vent caps and the hinge pins on the battery cover.

While the invention has been described in its preferred embodiments, it is to be understood that the words which have been used are words of description and not of limitation. Therefore, changes may be made within the scope of the appended claims without departing from the true scope and spirit of the invention.

1. A hinged battery cap assembly for a lead-acid battery comprising:
a battery cover comprising a watering fill well;
a removable cap adapted to seal the fill well; and
a hinge connecting the removable cap to the battery cover, the hinge comprising a hinge pin and a hinge socket, wherein the hinge pin floats within the hinge socket to allow movement of the hinge pin along the length of the hinge pin with respect to the hinge socket.

2. A battery cap assembly according to claim 1 further including at least one seal.

3. A battery cap assembly according to claim 1 further comprising an indicator pin adapted to engage an aperture in the cap when the cap is in a sealed position.

4. A battery cap assembly according to claim 1 wherein the fill well includes a stop ring at a bottom end.

5. A battery cap assembly according to claim 1 wherein the hinge socket is larger than the hinge pin.

6. A battery cap assembly according to claim 5 wherein the hinge pin can be snapped into and out of the hinge socket.

7. A battery cap assembly according to claim 1 and further comprising additional removable caps, wherein each removable cap is joined to a flip top cover.

8. A ganged battery cap assembly for a lead-acid battery comprising:
a battery cover comprising a plurality of watering fill wells;
a removable cap associated with each watering fill well and adapted to seal the respective watering fill well;
a hinge connecting each removable cap to the battery cover; and
a flip top cover adapted to join the plurality of removable caps to one another, wherein each removable cap is joined to the flip top cover with an amount of play such that each removable cap independently floats with respect to the flip top cover.

9. A ganged battery cap assembly according to claim 7 wherein each cap further comprises at least one seal adapted to seal the cap to its respective watering fill well.

10. A ganged battery cap assembly according to claim 7 further comprising an indicator pin associated with each fill well, each indicator pin adapted to engage a corresponding aperture in the cover when the caps are in sealed positions.

11. A ganged battery cap assembly according to claim 7 wherein each fill well includes a stop ring at a bottom end.

12. A ganged battery cap assembly according to claim 7 wherein each hinge socket is slightly larger than the corresponding hinge pin to allow movement of the hinge pin in three dimensions with respect to the hinge socket.

13. A ganged battery cap assembly according to claim 7 wherein the flip top cover further comprises at least one elastically deformable bracket for joining the cap to the flip top cover.

14. A battery cap assembly for a lead-acid battery comprising:
a battery cover comprising a removable watering fill well;
a removable cap adapted to seal the watering fill well; and
a hinge connecting the removable cap to the watering fill well, the hinge comprising a hinge pin and a hinge socket, wherein the hinge pin floats within the hinge socket to allow movement of the hinge pin along the length of the hinge pin with respect to the hinge socket.

15. A battery cap assembly according to claim 14 further including at least one seal.

16. A battery cap assembly according to claim 14 further comprising an indicator pin adapted to engage an aperture in the cap when the cap is in a sealed position.

17. A battery cap assembly according to claim 14 wherein the fill well includes a stop ring at a bottom end.

18. A battery cap assembly according to claim 14 wherein the hinge socket is larger than the hinge pin.

19. A battery cap assembly according to claim 18 wherein the hinge pin can be snapped into and out of the hinge socket.

20. A battery cap assembly according to claim 14 and further comprising additional removable caps, wherein each removable cap is joined to a flip top cover.

21. A cover and cap combination for a battery comprising:
a battery cover comprising at least one fill well defining a fill opening adapted to provide access into the battery, the fill opening defining at least one inwardly directed ear, and the fill well including an interior stop ring spaced a distance from the fill opening and extending into the battery;
at least one battery cap adapted to seal the at least one fill opening, the battery cap comprising a seal and a pair of downwardly extending claw-shaped flanges adapted to removably engage the at least one ear of the fill opening, and by so engaging the at least one ear, to hold the seal against the fill opening; and
at least one hinge fastening the at least one battery cap to the battery cover.

22. The cover and cap combination of claim 21 wherein the at least one fill opening defines a pair of inwardly directed ears.

23. The cover and cap combination of claim 21 further comprising a plurality of fill wells and corresponding pluralities of battery caps and hinges.

24. The cover and cap combination of claim 21 wherein the at least one hinge comprises at least one hinge socket integral to the battery cover and a hinge pin integral to the at least one battery cap.

25. The cover and cap combination of claim 24 wherein the at least one hinge comprises a pair of hinge sockets integral to the battery cover.

26. The cover and cap combination of claim 21 wherein the fill well comprises a generally cylindrical, longitudinally slotted tube extending into the battery.

27. The cover and cap combination of claim 26 wherein the generally cylindrical tube defines a first diameter at the fill opening, and necks down to a second diameter smaller than the first diameter between the fill opening and the stop ring.

28. A cover and cap combination for a battery comprising:
a battery cover comprising a plurality of fill wells, each fill well defining a fill opening adapted to provide access into the battery, each fill opening defining at least one inwardly directed ear, and each fill well including an interior stop ring spaced a distance from the fill opening and extending into the battery;
a plurality of battery caps, each corresponding to one of the plurality of fill wells, each battery cap adapted to seal a corresponding fill opening and comprising a seal and a pair of downwardly extending claw-shaped flanges adapted to removably engage the at least one ear of the corresponding fill opening, and by so engaging the at least one ear, to hold the seal against the fill opening; and
a plurality of hinges, each hinge fastening a battery cap to the battery cover.

29. The cover and cap combination of claim 28 wherein each fill opening defines a pair of inwardly directed ears.

30. The cover and cap combination of claim 28 wherein each hinge comprises at least one hinge socket integral to the battery cover and a hinge pin integral to a battery cap.

31. The cover and cap combination of claim 30 wherein each hinge comprises a pair of hinge sockets integral to the battery cover.

32. The cover and cap combination of claim 28 wherein each fill well comprises a generally cylindrical, longitudinally slotted tube extending into the battery.

33. The cover and cap combination of claim 32 wherein each generally cylindrical tube defines a first diameter at the fill opening, and necks down to a second diameter smaller than the first diameter between the fill opening and the stop ring.
